(19) United States
(12) Patent Application Publication
(10) Pub. No.: US 2014/0240487 A1
(43) Pub. Date: Aug. 28, 2014

(54) VEHICLE-TO-VEHICLE DISTANCE CALCULATION APPARATUS AND METHOD

(71) Applicant: FUJIFILM Corporation, Tokyo (JP)

(72) Inventors: Shunichiro NONAKA, Tokyo (JP); Yuko MATSUI, Tokyo (JP)

(73) Assignee: FUJIFILM Corporation, Tokyo (JP)

(21) Appl. No.: 14/169,884

(22) Filed: Jan. 31, 2014

(30) Foreign Application Priority Data
Feb. 28, 2013 (JP) 2013-038686

(51) Int. Cl. G06K 9/00; G06T 7/00; B60R 11/04

(52) U.S. Cl. CPC G06K 9/00791; B60R 11/04; G06T 7/0085
USPC 348/118

(57) ABSTRACT

The distance between vehicles is calculated in a comparatively simple and accurate manner. To achieve this, a target vehicle traveling ahead of one's own vehicle is imaged by a camera mounted one one's own vehicle. The image of the target vehicle is detected from the captured image. The position of a vanishing point and the position of a lower edge of the image representing the target image are detected from the captured image. The distance to the target vehicle is calculated based upon the detected positions.

### BACKGROUND OF THE INVENTION

1. Field of the Invention

This invention relates to a vehicle-to-vehicle distance calculation apparatus and method.

2. Description of the Related Art

Calculation of vehicle-to-vehicle distance is important in order to prevent vehicular accidents. In order to achieve this, there is a system that detects the shadow of the vehicle traveling ahead of one's own vehicle and calculates vehicle-to-vehicle distance using the position of the shadow and a vanishing point (Patent Document 1). Further, there is a system that detects an obstacle by utilizing a vanishing point (Patent Document 2) and a system that detects whether an object is a moving body by utilizing a vanishing point (Patent Document 3).

[Patent Document 1]: Japanese Patent Application Laid-Open No. 2002-327635

[Patent Document 2]: Japanese Patent Application Laid-Open No. 2007-199932

[Patent Document 3]: Japanese Patent Application Laid-Open No. 2006-48338

However, since the position of the shadow of the vehicle traveling ahead must be detected in Patent Document 1, the system is comparatively complex and cost of development is high. In addition, there are instances where it takes too much time to calculate distance. Furthermore, since it is difficult to detect a shadow at night or on a snow-covered road, etc., there are instances where distance cannot be calculated. Further, in both Patent Documents 1 and 2, no consideration is given to calculation of vehicle-to-vehicle distance in a comparatively simple and accurate manner.

### SUMMARY OF THE INVENTION

An object of the present invention is to calculate vehicle-to-vehicle distance comparatively simply and accurately.

A vehicle-to-vehicle distance calculation apparatus according to the present invention comprises: an imaging control device for controlling a camera, which has been mounted on one's own vehicle, so as to image ahead of one's own vehicle; an edge detection device for detecting at least one of an upper edge and lower edge of a target-vehicle image, which represents a target vehicle, from within an image obtained by imaging by the camera; a vanishing point detection device for detecting a vanishing point from within the image obtained by imaging by the camera; and a distance calculation device for calculating the distance to the target vehicle based upon a position of at least one of the upper edge and lower edge detected by the edge detection device and position of the vanishing point detected by the vanishing point detection device.

The invention also provides a vehicle-to-vehicle distance calculation method. Specifically, the invention provides a method of calculating vehicle-to-vehicle distance, comprising steps of: controlling a camera, which has been mounted on one's own vehicle, so as to image ahead of one's own vehicle; detecting at least one of an upper edge and lower edge of a target-vehicle image, which represents a target vehicle, from within an image obtained by imaging by the camera; detecting a vanishing point from within the image obtained by imaging by the camera; and calculating the distance to the target vehicle based upon a position of at least one of the upper edge and lower edge detected and position of the vanishing point detected.

In accordance with the present invention, what is ahead of one's own vehicle is imaged. At least one of an upper edge and lower edge of a target-vehicle image representing a target vehicle is detected from within the captured image. The distance to the target vehicle is calculated based upon the position of at least one of the detected upper edge and lower edge of the target-vehicle image and the position of the vanishing point. If the target-vehicle image is detected, then at least one of the upper edge and lower edge of the target-vehicle image is detected. As a result, the distance to the target vehicle is detected comparatively simply.

The edge detection device detects, by way of example, both the upper and lower edges of a target-vehicle image, which represents the target vehicle, from within the image obtained by imaging by the camera. In this case, the distance calculation device may include: a first distance calculation device for calculating a first distance to the target vehicle based upon the upper edge of the target-vehicle image detected by the edge detection device and the position of the vanishing point detected by the vanishing point detection device; and a second distance calculation device for calculating a second distance to the target vehicle based upon the lower edge of the target-vehicle image detected by the edge detection device and the position of the vanishing point detected by the vanishing point detection device. The distance to the target vehicle can be calculated based upon the first distance calculated by the first distance calculation device and the second distance calculated by the second distance calculation device.

Further, the edge detection device may be one that detects at least the lower edge of the target-vehicle image detected by the edge detection device. In this case, the apparatus may further comprise: a determination device for determining whether a tire of the target vehicle is absent below the lower edge detected by the edge detection device; and a correction device for correcting the position of the lower edge, which has been detected by the edge detection device, in response to a determination by the determination device that a shadow or tire of the target vehicle is absent below the lower edge detected by the edge detection device. The distance calculation device would calculate the distance to the target vehicle using the position of the lower edge corrected by the correction device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the relationship between one's own vehicle and a target vehicle;

FIG. 2 is a block diagram illustrating the electrical configuration of a vehicle-to-vehicle distance calculation apparatus;

FIGS. 3 and 4 are examples of images obtained by imaging;

FIGS. 5 and 6 illustrate driving tendencies;

FIGS. 7 and 8 are examples of target-vehicle images; and

FIG. 9 illustrates the relationship between one's own vehicle and a target vehicle.

### DESCRIPTION OF THE PREFERRED EMBODIMENTS

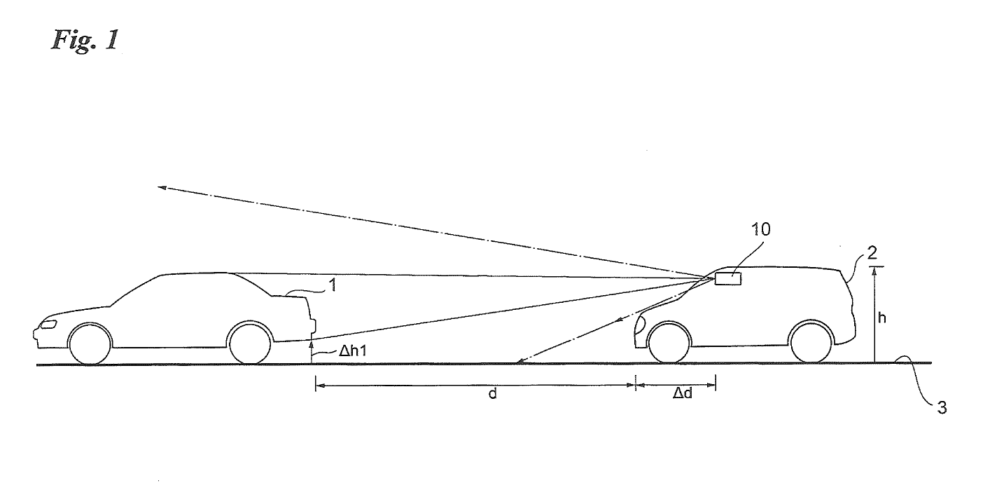

FIG. 1 represents in side view the relationship between one's own vehicle 2 and a target vehicle 1 traveling ahead of the vehicle 2.

One's own vehicle (an automotive vehicle) 2 is traveling on a road 3 and the target vehicle (an automotive vehicle) 1, whose vehicle-to-vehicle distance d is to be calculated, is traveling ahead of one's own vehicle 2.

A camera 10 is mounted within one's own vehicle 2 at the forward end near the top of the vehicle. What is ahead of one's own vehicle 2 is imaged by the camera 10. The position at which the camera 10 is mounted is at a height h from the road 3. The vehicle-to-vehicle distance d from one's own vehicle 2 to the target vehicle 1 is calculated based upon the image captured by the camera 10. A length obtained by subtracting a length Δd of the hood of one's own vehicle 2 from the distance from the camera 10 to the target vehicle 1 is the vehicle-to-vehicle distance d from one's own vehicle 2 to the target vehicle 1.

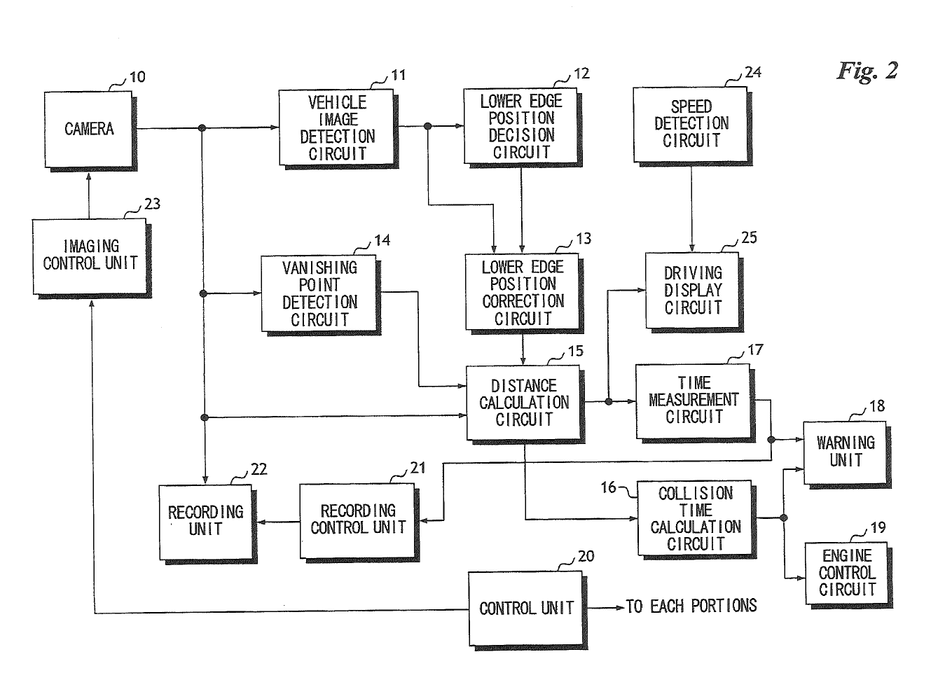

FIG. 2 is a block diagram illustrating the electrical configuration of a vehicle-to-vehicle distance calculation apparatus.

The overall operation of the vehicle-to-vehicle distance calculation apparatus is controlled by a control unit 20.

The camera 10 is controlled by an imaging control unit 23. What is ahead of one's own vehicle 2 is imaged by the camera 10, as mentioned above.

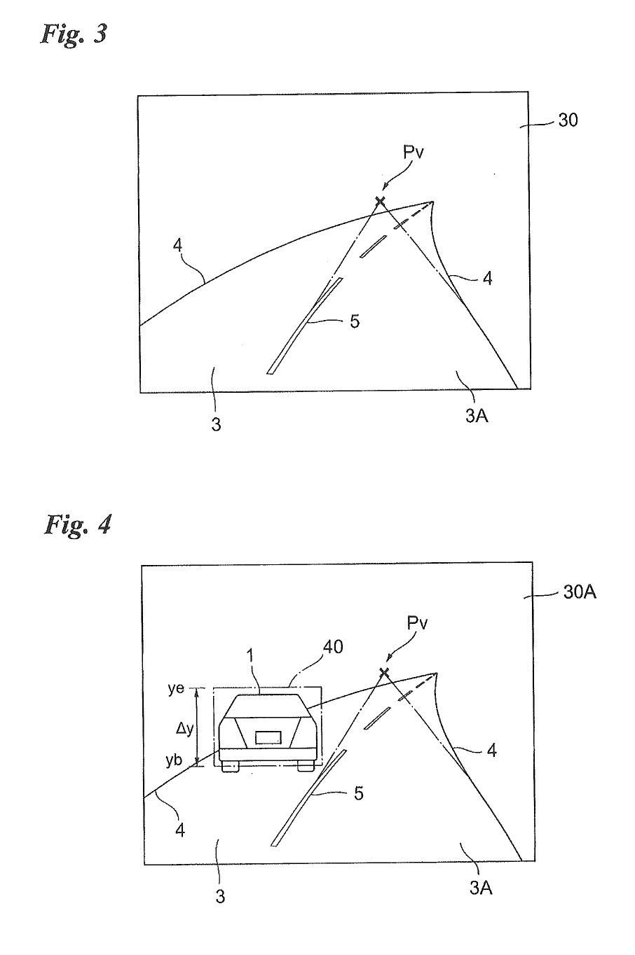

FIG. 3 is an example of an image 30 obtained by imaging.

The image 30 contains a road image 3 (indicated by the same reference numeral as that of the road 3) representing the road 3 of the lane along which one's own vehicle 2 travels, and a road image 3A of the lane along which oncoming vehicles travel. An image 5 of the center line of the road is displayed between the road image 3 of one's own traveling lane and the road image 3A of the traveling lane of oncoming vehicles. Further, an image 4 of a roadway boundary block is displayed on the left side of the road image 3 and on the right side of the road image 3A.

In this embodiment, a vanishing point Pv is utilized in order to measure the distance to the target vehicle 1.

The vanishing point Pv is located at a position where an extension of the roadway boundary block 4 intersects an extension of the center line 5. In a case where either one of these cannot be found, the vanishing point Pv may be obtained by the position where either one of these intersects these parallel lines (e.g., an extension of a guard rail).

FIG. 4 is an example of an image 30A obtained by imaging.

The image 30A contains a target-vehicle image 1 representing the target vehicle 1 that travels ahead of one's own vehicle 2. A frame 40 that specifies the target-vehicle image 1 detected from the image 30A also is displayed surrounding the target-vehicle image 1.

In this embodiment, a Y-coordinate (a coordinate along the vertical direction) position yb of the lower end of the target-vehicle image 1 is detected, and a Y-coordinate position ye of the vanishing point Pv is detected. The distance to the target vehicle 1 is calculated using the difference Ay between the detected positions yb and ye.

With reference again to FIG. 2, when what is ahead of one's own vehicle 2 is imaged by the camera 10, the image data representing the captured image is input to a vehicle image detection circuit 11. In the vehicle image detection circuit 11, the target-vehicle image 1 is detected from within the image 30 as mentioned above. Data representing the detected target-vehicle image 1 is applied to a lower edge position decision circuit 12.

The lower edge position decision circuit 12 detects the position yb of the lower edge of the target vehicle (target-vehicle image 1) traveling ahead of one's own vehicle 2. Data representing the detected position yb is input to a lower edge position correction circuit 13. The lower edge position correction circuit 13 corrects the detected lower edge position yb. The details concerning this correction processing will be described later. Data representing the lower-edge position corrected in the lower edge position correction circuit 13 is input to a distance calculation circuit 15.

Further, data representing the image captured by the camera 10 is input to a vanishing point detection circuit 14 as well. The vanishing point detection circuit 14 detects the vanishing point from the captured image. Data indicating the position ye of the detected vanishing point also is input to the distance calculation circuit 15.

The distance calculation circuit 15 calculates the distance to the target vehicle 1 utilizing data such as the entered data indicating the vanishing-point position ye and data indicating the lower-edge position yb of the target vehicle 1. The details concerning this calculation will be described later.

Data representing vehicle-to-vehicle distance every unit time is input to a collision time calculation circuit 16, time measurement circuit 17 and driving display circuit 25.

The time measurement circuit 17 checks to determine whether a state in which the vehicle-to-vehicle distance is less than a hazardous distance at which the danger of a collision will occur has continued to a certain extent. If this state where the vehicle-to-vehicle distance is less than the hazardous distance continues to a certain extent, data indicative of this fact is applied from the time measurement circuit 17 to a warning unit 18. The warning unit 18 issues a warning to the driver of vehicle 2 in the form of a warning tone or warning display, etc. Further, a recording control unit 21 is controlled so that the image data captured by the camera 10 is recorded in a recording unit 22 as moving image data indicative of hazardous driving and as continuous still image data.

When the data representing the vehicle-to-vehicle distance is applied to the collision time calculation circuit 16 every unit time, the collision time calculation circuit 16 predicts the time at which the vehicle-to-vehicle distance will become zero. If the collision prediction time reaches a predetermined time, the collision time calculation circuit 16 applies data to this effect to the warning unit 18. The warning unit 18 issues a warning in the manner described above. Further, an engine control circuit 19 is controlled in such a manner that a collision will not occur, and the speed of one's own vehicle 2 is thus diminished.

Further, the speed of one's own vehicle 2 is detected by a speed detection circuit 24. Data indicating the detected speed is applied to the driving display circuit 25.

The driving display circuit 25 displays a graph indicative of a driver's driving tendency, which indicates the relationship between the traveling speed of one's own vehicle 2 and vehicle-to-vehicle distance.

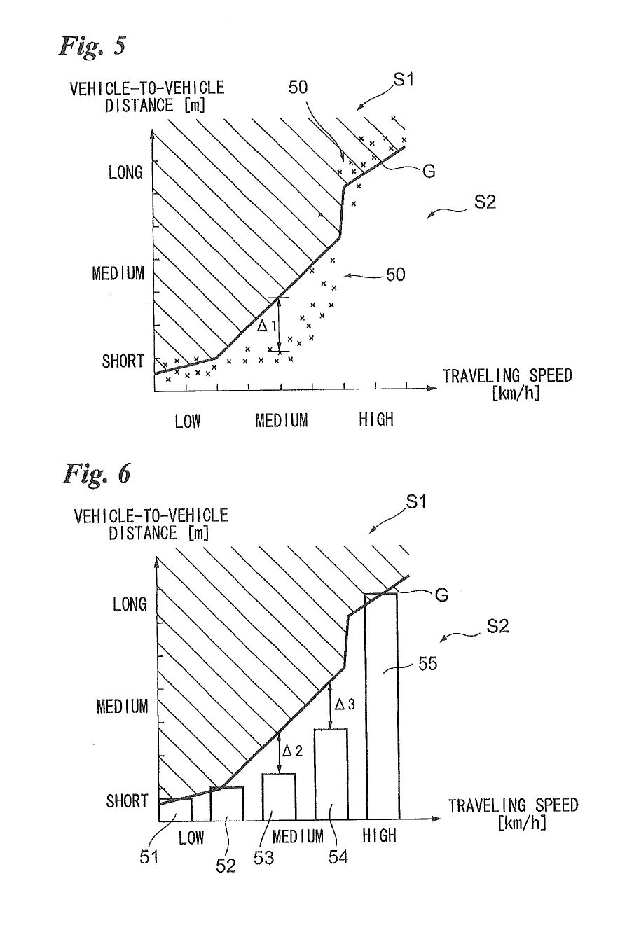

FIGS. 5 and 6 are examples of displays of driving tendency. In both examples the horizontal axis is a plot of traveling speed and the vertical axis a plot of vehicle-to-vehicle distance.

In FIGS. 5 and 6, a graph G indicates a relationship, which is considered safe for driving, between traveling speed and vehicle-to-vehicle distance.

The relationship between traveling speed and vehicle-to-vehicle distance illustrated by graph G changes depending upon the traveling speed. If traveling speed is low, a comparatively short vehicle-to-vehicle distance is acceptable. If traveling speed is medium, however, then a comparatively greater vehicle-to-vehicle distance is necessary. When traveling speed is high, a long vehicle-to-vehicle distance is necessary.

If vehicle-to-vehicle distance is greater than the vehicle-to-vehicle distance indicated by graph G such that the relationship between vehicle-to-vehicle distance and traveling speed falls within a region S1 indicated by the hatching, then this is indicative of a safe driving pattern. On the other hand, if the relationship between vehicle-to-vehicle distance and traveling speed falls within a region S2 so that the vehicle-to-vehicle distance is less than the vehicle-to-vehicle distance indicated by graph G, then this is indicative of a hazardous driving pattern. These patterns are obtained in conformity with traveling speed.

FIG. 5 illustrates safe driving and hazardous driving tendencies based upon a scatter diagram.

A number of points 50 indicating the relationship between traveling speed and vehicle-to-vehicle distance are illustrated as mentioned above. The driving tendency of the driver can be understood in accordance with the distribution of the points 50. In cases where traveling speed is low in FIG. 5, the driver is engaged in substantially safe driving, but when traveling speed rises to the medium level, the vehicle-to-vehicle distance shortens and the tendency indicated is one of hazardous driving. Further, it will be understood that when traveling speed is high, the vehicle-to-vehicle distance becomes long and the tendency indicated is one of safe driving. For example, an arrangement may be adopted in which a difference Al between a required vehicle-to-vehicle distance and the actual vehicle-to-vehicle distance is calculated at a specific traveling speed and the driver is notified of the existence of this difference Al.

FIG. 6 illustrates driver tendency using a bar graph.

The relationship between traveling speed and vehicle-to-vehicle distance is illustrated by multiple bars 51 to 55 of the bar graph. It will be understood that whereas bars 51, 52 which result when traveling speed is low indicate that the necessary vehicle-to-vehicle distance exists, bars 53, 54 which result when traveling speed is medium indicate that the vehicle-to-vehicle distance is shorter than the necessary vehicle-to-vehicle distance and, hence, that driving is hazardous. Further, it will be understood that bar 55 which results when traveling speed is high indicates that the vehicle-to-vehicle distance is the necessary vehicle-to-vehicle distance and that driving is comparatively safe.

The driving tendency of the driver is thus displayed by the driving display circuit 25. The driver can dedicate himself to safe driving while viewing the display.

Further, an arrangement may be adopted in which data indicating the relationship between calculated traveling speed and vehicle-to-vehicle distance is extracted and the above-described driving display is presented at the driver's home or office or the like at the conclusion of driving.

Reference will be had to FIGS. 1 and 4 to describe a method of calculating vehicle-to-vehicle distance d to the target vehicle using the lower-edge position yb of the target-vehicle image and the vanishing-point position ye.

With reference to FIG. 1, and as mentioned above, let d represent the vehicle-to-vehicle distance, let Δd represent the distance from the position at which the camera 10 is mounted on one's own vehicle 2 to the front end of one's own vehicle 2, and let h represent the height at which the camera 10 is mounted. Further, let Δh1 represent the height of the lower edge of the rear end of target vehicle 1 from the road 3.

Furthermore, with reference to FIG. 4, and as mentioned above, let ye represent the Y-coordinate position of the vanishing point Pv in the image 30A obtained by imaging, let yb represent the Y-coordinate position of the lower edge of the rear end of the detected target-vehicle image 1. Further, let Ay represent the distance between the Y-coordinate positions ye and yb.

If we let Δθ (rad) represent the angular resolution per Y-coordinate value 1 of camera 10, then Equation 1 below will hold.

dy·Δθ (rad)=(h−Δh1)/(d+Δd) Equation 1

The vehicle-to-vehicle distance d can be calculated from Equation (1).

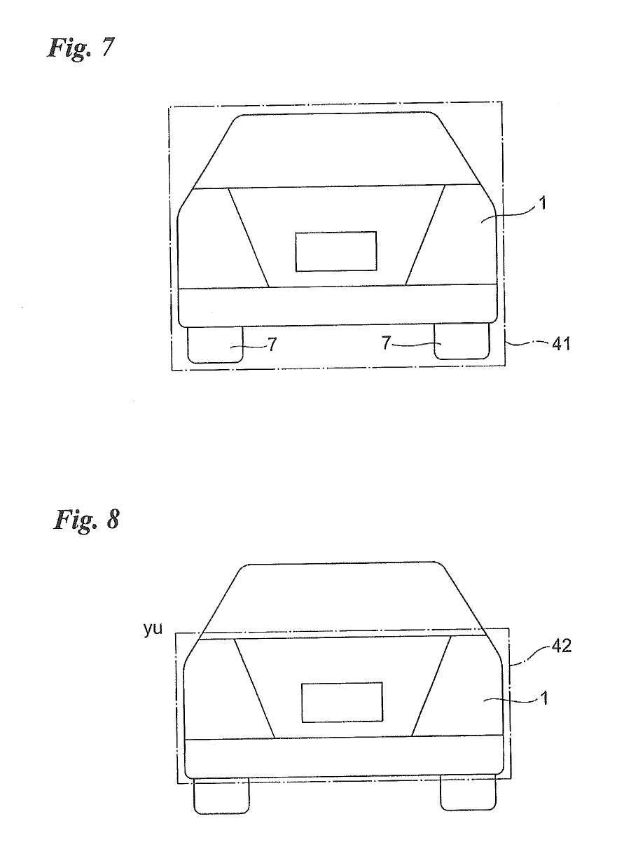

FIG. 7 is one example of the target-vehicle image 1 detected from the captured image 30A.

The detected target-vehicle image 1 contains an image 7 of a tire. If the target vehicle is detected as the target-vehicle image 1 inclusive of the tire image 7, then a detection frame 41 at this time will be lower than the detection frame 40 that results when the tire image 7 is not included in the target-vehicle image. As a consequence, the Y-coordinate position yb of the lower edge of the rear end of target-vehicle image 1 detected as set forth above will be lower by an amount commensurate with the tire image 7. As shown in FIG. 1, therefore, the vehicle-to-vehicle distance d will be calculated taking into consideration the portion equivalent to the height of the tire image 7 of the target vehicle 1. The vehicle-to-vehicle distance d is calculated in accordance with Equation 2 below.

dy·Δθ (rad)=h/(d+Δd) Equation 2

If the detected target-vehicle image 1 does not contain the tire image 7, the lower-edge position is corrected by the lower edge position correction circuit 13 in such a manner that the vehicle-to-vehicle distance d will be calculated based upon Equation 2. The determination as to whether the target-vehicle image 1 does not contain the tire image 7 may be made by verifying whether the tire image 7 is not included in the lower portion of the detection frame 40 or 41, or by verifying whether the tire image 7 is not included beneath the frame 40 or 41 on the outer side thereof.

FIG. 8 is one example of the target-vehicle image 1 detected from the captured image 30A.

In the foregoing embodiment, the vehicle-to-vehicle distance d is calculated utilizing the Y-coordinate position yb of the lower edge of target-vehicle image 1. However, the vehicle-to-vehicle distance can be calculated also by utilizing a Y-coordinate position yu of the upper edge of the rear end of target-vehicle image 1.

The rear end of the target-vehicle image 1 is detected and is enclosed by a detection frame 42. The detection frame 42 encloses the target-vehicle image 1 so as to exclude the rear window of the target vehicle. The upper edge of the detection frame 42 is the Y-coordinate position yu.

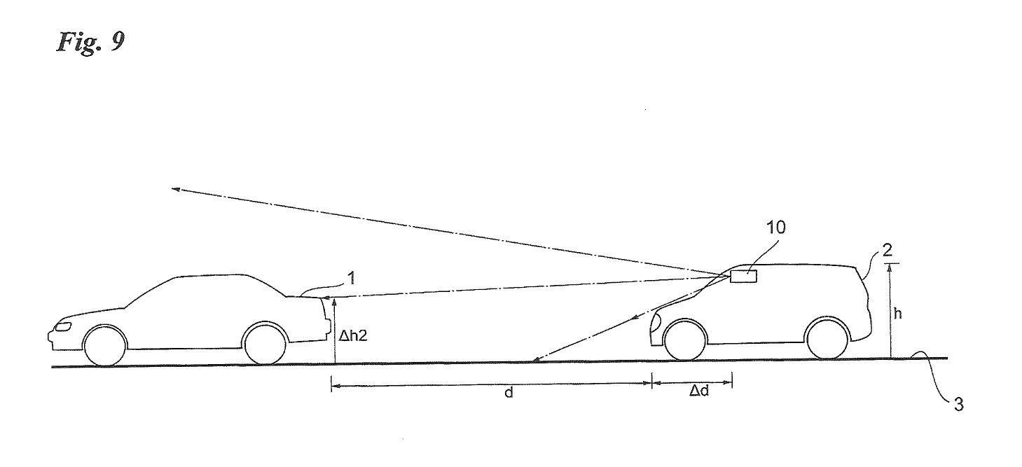

FIG. 9, which corresponds to FIG. 1, is a side view showing the relationship between one's own vehicle 2 and the target vehicle 1.

Since the upper portion of the rear end of target vehicle 1 is at a position having a height Δh2 from the road 3, the vehicle-to-vehicle distance d is calculated in accordance with Equation 3.

dy·Δθ (rad)=(h−Δh2)/(d+Δd) Equation 3

A more accurate vehicle-to-vehicle distance can be calculated by adopting the average distance of the vehicle-to-vehicle distance d calculated from Equation 1 or 2 and the vehicle-to-vehicle distance d calculated from Equation 3 as the vehicle-to-vehicle distance. In a case where the vehicle-to-vehicle distance d is calculated in accordance with Equation 3, the upper-edge position yu would be decided in the above-described lower edge position decision circuit 12, and data representing the upper-edge position yu, the lower-edge position yb and the vanishing-point position ye would be input to the distance calculation circuit 15.

As many apparently widely different embodiments of the present invention can be made without departing from the spirit and scope thereof, it is to be understood that the invention is not limited to the specific embodiments thereof except as defined in the appended claims.

What is claimed is:

1. A vehicle-to-vehicle distance calculation apparatus comprising:
an imaging control device for controlling a camera, which has been mounted on one's own vehicle, so as to image ahead of one's own vehicle;
an edge detection device for detecting at least one of an upper edge and lower edge of a target-vehicle image, which represents a target vehicle, from within an image obtained by imaging by the camera;
a vanishing point detection device for detecting a vanishing point from within the image obtained by imaging by the camera; and
a distance calculation device for calculating the distance to the target vehicle based upon a position of at least one of the upper edge and lower edge detected by said edge detection device and position of the vanishing point detected by said vanishing point detection device.

2. The apparatus according to claim 1, wherein said edge detection device detects both the upper and lower edges of a target-vehicle image, which represents the target vehicle, from within the image obtained by imaging by the camera; and
said distance calculation device includes:
a first distance calculation device for calculating a first distance to the target vehicle based upon the upper edge of the target-vehicle image detected by said edge detection device and the position of the vanishing point detected by said vanishing point detection device; and
a second distance calculation device for calculating a second distance to the target vehicle based upon the lower edge of the target-vehicle image detected by said edge detection device and the position of the vanishing point detected by said vanishing point detection device;
said distance calculation device calculating the distance to the target vehicle based upon the first distance calculated by said first distance calculation device and the second distance calculated by said second distance calculation device.

3. The apparatus according to claim 1, wherein said edge detection device detects at least the lower edge of the target-vehicle image detected by said edge detection device, and said apparatus further comprises:
a determination device for determining whether a tire of the target vehicle is absent below the lower edge of the target-vehicle image detected by said edge detection device; and
a correction device for correcting the position of the lower edge, which has been detected by said edge detection device, in response to a determination by said determination device that a shadow or tire of the target vehicle is absent below the lower edge detected by said edge detection device.

4. A vehicle-to-vehicle distance calculation method comprising the steps of:
controlling a camera, which has been mounted on one's own vehicle, so as to image ahead of one's own vehicle;
detecting at least one of an upper edge and lower edge of a target-vehicle image, which represents a target vehicle, from within an image obtained by imaging by the camera;
detecting a vanishing point from within the image obtained by imaging by the camera; and
calculating the distance to the target vehicle based upon a position of at least one of the upper edge and lower edge detected and position of the vanishing point detected.
